(19) United States
(12) Patent Application Publication
(10) Pub. No.: US 2009/0320300 A1
(43) Pub. Date: Dec. 31, 2009

(54) Pruning shears

(75) Inventor: Mei-Chih Liu, Taichung (TW)

Correspondence Address: BIRCH STEWART KOLASCH & BIRCH, PO BOX 747, FALLS CHURCH, VA, 22040-0747, US

(73) Assignee: SUCCESS & TECH INDUSTRIAL CO. ,LTD.

(21) Appl. No.: 12/213,840

(22) Filed: Jun. 25, 2008

(51) Int. Cl. B26B 13/00

(52) U.S. Cl. 30/262

(57) ABSTRACT

Pruning shears include a first arm comprising a first handle having a latch block, and an integral jaw having a recess; a second arm comprising a second handle and an integral joining section including a cavity and a peripheral trough; a first blade securely disposed on the recess and having a cutting edge; a second blade secured to the joining section for covering the cutting edge; a joint partially disposed on the cavity for pivotably securing the first arm to the second arm; a compression spring positioned between the arms; and a hollow locking member put on the latch block. Holding the arms toward each other to compress the spring and pushing the locking member toward the blades will lockingly engage the locking member with the trough. Pulling the locking member to disengage from the trough will open the shears.

### BACKGROUND OF THE INVENTION

1. Field of Invention

The invention relates to pruning shears and more particularly to such a pair of pruning shears with improved characteristics.

2. Description of Related Art

A conventional type of pruning shears is shown in FIG. 1. The shears have two arms 1 pivotably interconnected by means of a pivot joint (not numbered), a helical compression spring 3 positioned between the arms 1, and two cutting jaws 2 in which one jaw 2 has a notch 4. In a cutting operation, a plant material (e.g., a flower stalk, a branch, etc.) is introduced into a shear opening of the open shears and the shears are slowly closed for cutting through the material.

The provision of the notch 4 can facilitate the holding of the plant material in the shear opening. However, it also decreases the structural strength of the jaws 2. The jaws 2 are thus subject to break after a period time of use. Further, its cutting operation is not smooth.

Another conventional type of pruning shears is shown in FIG. 2. The shears have two arms 5 pivotably interconnected by means of a pivot joint (not numbered), a compression spring 7 positioned between the arms 5, and two cutting jaws 6. One jaw 6 has a through hole (not shown) and the front end of one arm 5 has a through hole 9. A fastener (e.g., screw) 8 is driven into both through holes 9 to secure the jaw 6 and the arm 5 together.

However, the provision of the through holes can decrease the structural strength of the shears. The shears are thus subject to break after a period time of use.

There have been numerous suggestions in prior patents for pruning shears. A pertinent prior art of which this inventor is aware is U.S. Pat. No. 6,634,105.

A need remains for a pair of improved pruning shears in order to contribute significantly to the advancement of the art.

### SUMMARY OF THE INVENTION

It is therefore one object of the invention to provide a pair of pruning shears with increased structural strength and being adapted to operate smoothly.

The above and other objects, features and advantages of the invention will become apparent from the following detailed description taken with the accompanying drawings.

### BRIEF DESCRIPTION OF THE DRAWINGS

FIG. 1 is a side elevation of a conventional pruning shears in a closed position;

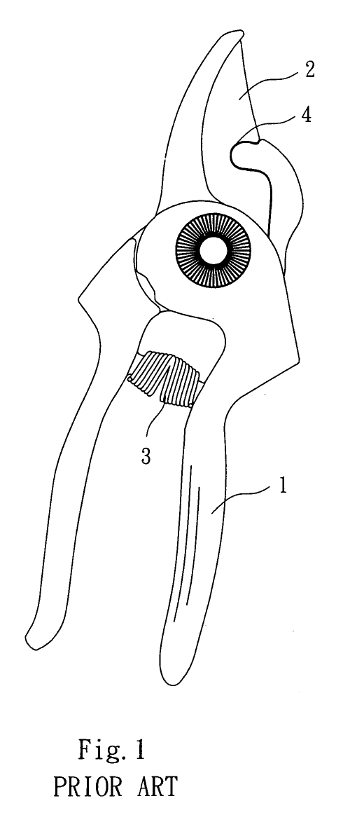

FIG. 2 is a perspective view of another conventional pruning shears in an open position;

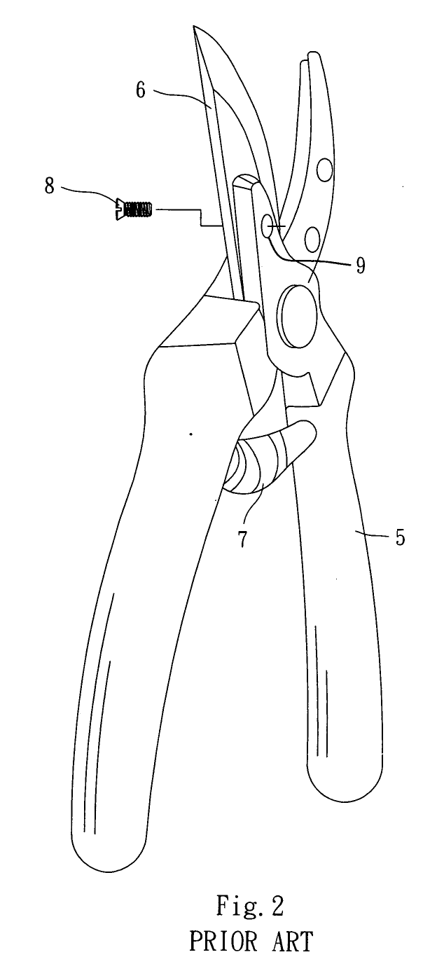

FIG. 3 is an exploded view of a preferred embodiment of pruning shears according to the invention;

FIG. 4 is a side elevation of the assembled pruning shears shown in FIG. 3 where the shears are in a closed position;

FIG. 5 is a sectional view taken along line A-A of FIG. 4;

FIG. 6 is another side elevation of the handle of the shears shown in FIG. 4 but taken from an opposite angle;

FIG. 7 is a view similar to FIG. 4 where the shears are in an open position;

FIG. 8 is a sectional view taken along line B-B of FIG. 7; and

FIG. 9 is a view similar to FIG. 6 where the shears are open.

### DETAILED DESCRIPTION OF THE INVENTION

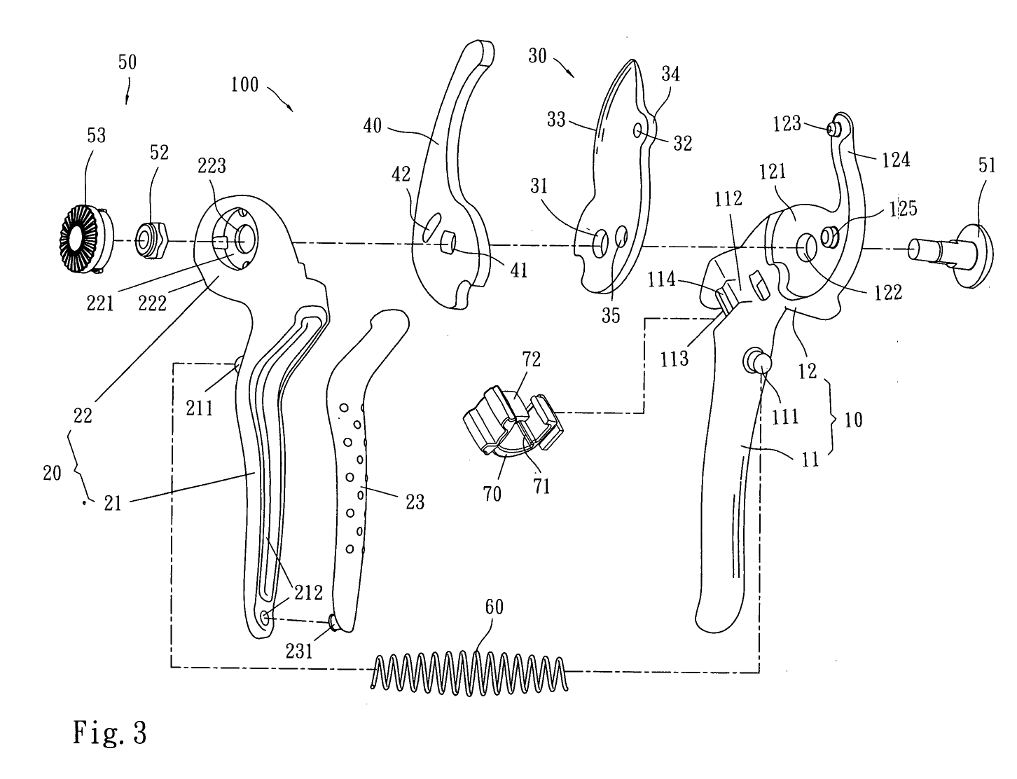

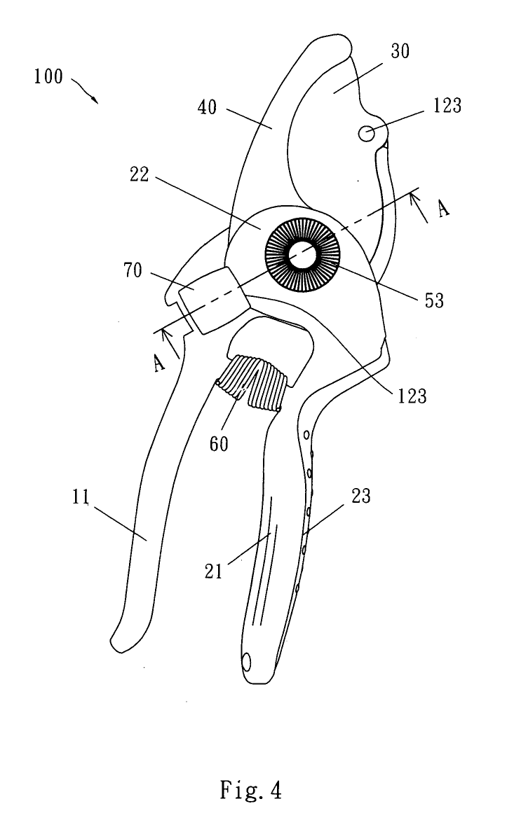

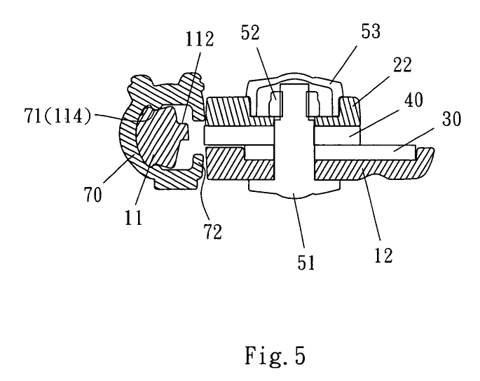

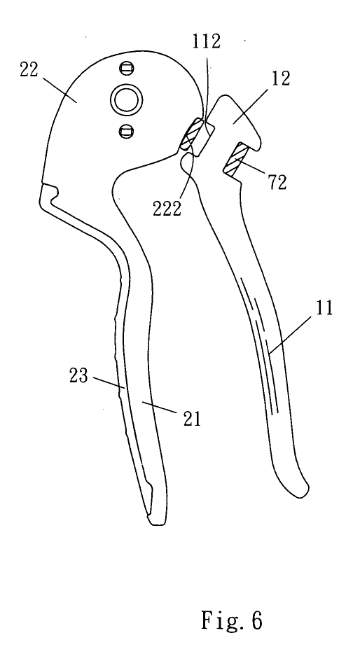

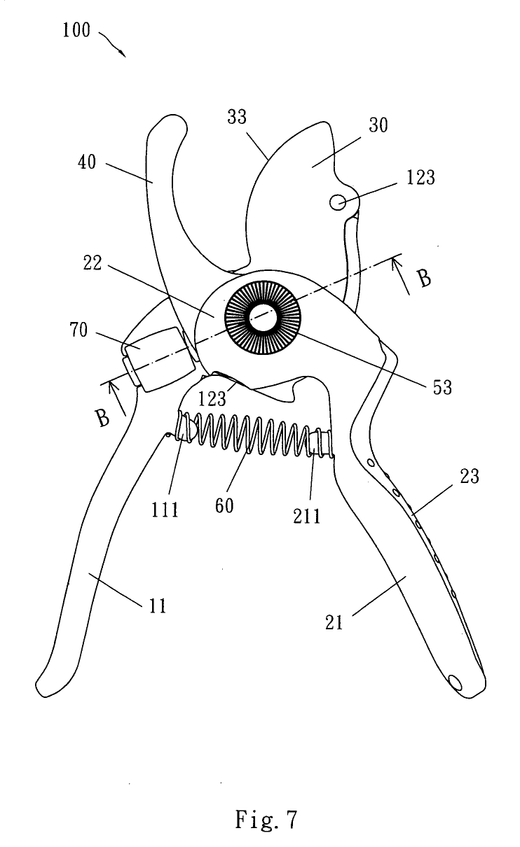

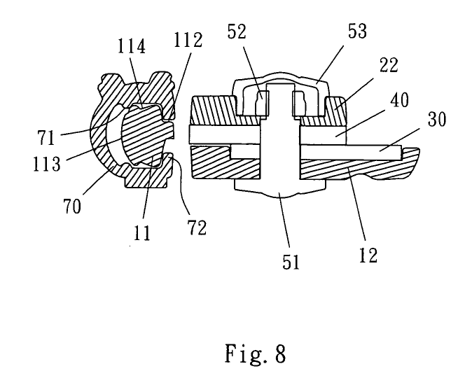

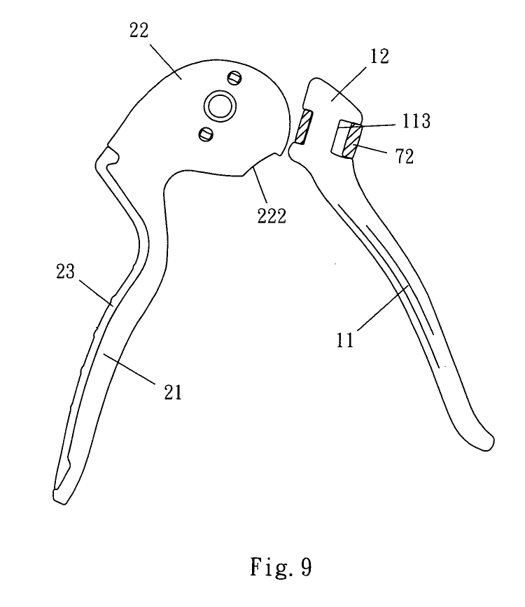

Referring to FIGS. 3 to 9, a pair of pruning shears in accordance with a preferred embodiment of the invention is generally designated by numeral 100. The shears 100 comprise the following components as discussed in detail below.

A first arm 10 comprises a first handle 11 and an integral jaw 12. The first handle 11 has a cylindrical protrusion 111 projecting inward proximate the jaw 12, and a latch block 112 at the joining portion of the first handle 11 and the jaw 12, the latch block 112 having a groove 114 on either side, and a tang 113 joining the grooves 114.

The jaw 12 comprises a flat recess 121 on the inner surface, a hole 122 through the recess 121, a second tab 125 proximate the hole 122, an arm-shaped actuating section 124, and a first tab 123 at one end of the actuating section 124.

A second arm 20 comprises a second handle 21 and a joining section 22 integrally formed at one end of the second handle 21. The second handle 21 comprises a cylindrical protrusion 211 projecting inward proximate the joining section 22, and a recessed engagement 212 on the outer surface.

The second arm 20 further comprises an elongated covering 23 formed of elastomeric material, the covering 23 having a stub 231 at a lower end (see FIG. 3), the covering 23 being adapted to matingly secure to the engagement 212 by gluing or snapping. The covering 23 has a plurality of small raised members (not numbered) so as to facilitate the holding of the shears by the hand and give a degree of comfort thereto.

The joining section 22 comprises a circular cavity 221 on one surface with a hole 223 formed therethrough, and a trough 222 on its periphery facing the first arm 10.

A first blade 30 comprises a hole 31 at one end, an ear 34 on the periphery proximate the other end, the ear 34 having a first through hole 32, a second through hole 35 besides the hole 31, and a cutting edge 33 opposite the ear 34. The first blade 30 is shaped to fit on the recess 121 with the first tab 123 fastened in the first through hole 32, the second, tab 125 fastened in the first through hole 32, and the hole 31 aligned with the hole 122.

A second blade 40 comprises a second pivot hole 41 aligned with both the hole 31 and the hole 223, and a slot 42 besides the second pivot hole 41, the slot 42 being adapted to receive a corresponding mating member (not shown) of the second arm 20 so that the second blade 40 and the second arm 20 can be secured together.

A pivot joint 50 comprises a pivot pin 51, a sleeve 52 disposed on the cavity 221 of the joining section 22 and aligned with the hole 223, and a cup-shaped cap 53 securely fitted in the cavity 221 of the joining section 22. The pivot pin 51 is adapted to insert through the hole 122, the hole 31, the second pivot hole 41, the hole 223, and the sleeve 52 into the cap 53 to pivotably secure the first arm 10, the first blade 30, the second blade 40, and the second arm 20 together.

A helical compression spring 60 has one end securely put on the protrusion 111 and the other end securely put on the protrusion 211 so that the spring 60 can exert an expansion force to push the first arm 10 and the second arm 20 apart from each other. Thus, a clearance gap may exist between the cutting edge 33 and the second blade 40.

A hollow locking member 70 of substantially C section is provided. The locking member 70 has two opposite ridges 71 on both sides, and two latches 72 extending from the mouth facing each other. The locking member 70 is adapted to put on the latch block 112 with the ridges 71 fitted in the grooves 114 and the tang 113 engaged with the inner surface of the locking member 70. The locking member 70 is adapted to limit the pivotal movement of the first arm 10 about the second arm 20. Moreover, the first blade 30 and the second blade 40 can be maintained in a covering relationship. Further, the cutting edge 33 is prevented from being exposed.

For storing the shears 100, an individual may hold the arms 10, 20 toward each other with the spring 60 being compressed. Further, push the locking member 70 toward the blades 30, 40 until the latches 72 are lockingly engaged with the trough 222 and the ridges 71 fitted in the grooves 114. In this position, the shears 100 are locked. To the contrary, the individual may disengage the latches 72 from the trough 222 by pulling the locking member 70 prior to using the shears 100.

The invention has the following advantages. The structural strength of the first blade 30 is not decreased. Cutting operation is smooth.

While the invention herein disclosed has been described by means of specific embodiments, numerous modifications and variations could be made thereto by those skilled in the art without departing from the scope and spirit of the invention set forth in the claims.

1. Pruning shears (100) comprising:
a first arm (10) comprising a first handle (11) and an integral jaw (12) wherein the first handle (11) has a latch block (112) proximate the jaw (12), and the jaw (12) has a flat recess (121) on the inner surface, a hole (122) through the recess (121), a second tab (125) proximate the hole (122), an arm-shaped actuating section (124), and a first tab (123) at one end of the actuating section (124);
a second arm (20) comprising a second handle (21) and an integral joining section (22) including a cavity (221) on one surface with a hole (223) formed therethrough and a peripheral trough (222);
a first blade (30) securely disposed on the recess (121) and having a hole (31) at one end, an ear (34) on the periphery proximate the other end, the ear (34) having a first through hole (32), a second through hole (35) besides the hole (31), and a cutting edge (33) opposite the ear (34);
a second blade (40) secured to the joining section (22) and being disposed on the cutting edge (33) in an inoperative position of the shears (100);
a pivot joint (50) partially disposed on the cavity (221) for pivotably securing the first arm (10) to the second arm (20);
a biasing member (60) positioned between the first arm (10) and the second arm (20); and
a hollow locking member (70) put on the latch block (112);
wherein the second blade (40) comprises a second pivot hole (41) aligned with both the hole (31) and the hole (223), and a slot (42) besides the second pivot hole (41).

2. The pruning shears (100) of claim 1, wherein the locking member (70) is of substantially C section and has two opposite ridges (71) on both sides, and two opposite latches (72) on the opening.

3. The pruning shears (100) of claim 2, wherein the latch block (112) comprises a groove (114) on either side adapted to secure to the ridges (71), and a tang (113) joining the grooves (114).
